(19) United States
(12) Patent Application Publication
(10) Pub. No.: US 2017/0097887 A1
(43) Pub. Date: Apr. 6, 2017

(54) Storage Controller Cache Having Reserved Parity Area

(71) Applicant: NetApp, Inc., Sunnyvale, CA (US)

(72) Inventors: Brian McKean, Boulder, CO (US); Kevin Kidney, Boulder, CO (US); Don Humlicek, Wichita, KS (US)

(21) Appl. No.: 14/874,186

(22) Filed: Oct. 2, 2015

(51) Int. Cl. G06F 12/08; G06F 11/14; G06F 12/12

(52) U.S. Cl. CPC G06F 12/0804; G06F 12/12; G06F 11/1415; G06F 2212/1032; G06F 2212/604; G06F 2212/69; G06F 2201/805

(57) ABSTRACT

Systems and techniques for performing a data transaction are disclosed that provide improved cache performance by pinning recovery information in a controller cache. In some embodiments, a data transaction is received by a storage controller of a storage system. The storage controller determines whether the data transaction is directed to a data stripe classified as frequently accessed. Data associated with the data transaction and recovery information associated with the data transaction are cached in a cache of the storage controller. The recovery information is pinned in the cache based on the data transaction being directed to the data stripe that is classified as frequently accessed, and the data is flushed from the cache independently from the pinned recovery information.

### TECHNICAL FIELD

The present description relates to data storage and retrieval and, more specifically, to techniques and systems for caching data by a storage controller.

### BACKGROUND

Networks and distributed storage allow data and storage space to be shared between devices located anywhere a connection is available. These implementations may range from a single machine offering a shared drive over a home network to an enterprise-class cloud storage array with multiple copies of data distributed throughout the world. Larger implementations may incorporate Network Attached Storage (NAS) devices, Storage Area Network (SAN) devices, and other configurations of storage elements and controllers in order to provide data and manage its flow. Improvements in distributed storage have given rise to a cycle where applications demand increasing amounts of data delivered with reduced latency, greater reliability, and greater throughput. Building out a storage architecture to meet these expectations enables the next generation of applications, which is expected to bring even greater demand.

Many storage systems safeguard data by also storing recovery information such as redundant copies or parity bits because, while hardware and software are both faster and more reliable than ever, device failures have not been completely eliminated. Ideally, should a device fail, the data can be recovered using the recovery information. However, redundancy comes at a price. Many techniques for maintaining recovery information entail considerable overhead, which may result in more transaction latency and slower performance.

Therefore, in order to provide optimal data storage performance and protection, a need exists for systems and techniques for managing data that make efficient use of caches and processing resources to mitigate the penalties associated with recovery information. In particular, systems and methods that reduce the latency associated with maintaining recovery information while still protecting data integrity would provide a valuable improvement over conventional storage systems. Thus, while existing storage systems have been generally adequate, the techniques described herein provide improved performance and efficiency.

### BRIEF DESCRIPTION OF THE DRAWINGS

The present disclosure is best understood from the following detailed description when read with the accompanying figures.

FIG. 1 is a schematic diagram of an exemplary storage architecture according to aspects of the present disclosure.

FIG. 2 is a flow diagram of a method of cache management according to aspects of the present disclosure.

FIG. 3 is a memory diagram of a controller cache and a set of storage devices of exemplary storage architecture undergoing the method according to aspects of the present disclosure.

FIG. 4 is a memory diagram of an access log according to aspects of the present disclosure.

FIG. 5 is a memory diagram of the controller cache and the set of storage devices of exemplary storage architecture undergoing the method according to aspects of the present disclosure.

FIG. 6 is a memory diagram of the controller cache and the set of storage devices of exemplary storage architecture undergoing the method according to aspects of the present disclosure.

FIG. 7 is a memory diagram of the controller cache and the set of storage devices of exemplary storage architecture undergoing the method according to aspects of the present disclosure.

FIG. 8 is a memory diagram of the controller cache and the set of storage devices of exemplary storage architecture undergoing the method according to aspects of the present disclosure.

FIG. 9 is a memory diagram of the controller cache and the set of storage devices of exemplary storage architecture undergoing the method according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments except where explicitly noted. Finally, in view of this disclosure, particular features described in relation to one aspect or embodiment may be applied to other disclosed aspects or embodiments of the disclosure, even though not specifically shown in the drawings or described in the text.

Various embodiments provide a system, method, and machine-readable medium for a storage system that allocates space within a storage controller cache based on data utilization patterns. Specifically, hot data stripes are identified, and their recovery information (e.g., parity information) is stored in a reserved area of the controller cache. The recovery information is pinned in the reserved area and persists in the cache even after the associated data is flushed. Thus, there may be several reads and flushes of the data portions of the stripe before the recovery information is eventually written back. This is beneficial in applications where a write anywhere in a stripe includes accessing or modifying the stripe's recovery information because it increases the cache hit rate. In particular, writes to a large data stripes may not necessarily affect the same data segments, and as a result, the cache hit rate of the data may be significantly lower than the cache hit rate of the recovery information. By pinning only the recovery information for the hot data stripes rather than pinning both data and recovery information, this cache hit rate improvement may be achieved without the increased cache bloat associated with pinning data.

The embodiments disclosed herein may provide several advantages. First, during subsequent writes to the same hot stripe, the pinned recovery information may avoid at least one parity read and at least one parity write even if the data has already been flushed. The number of avoided transactions may be higher for RAID 6 and other multiple-parity schemes. By regularly flushing the data of the hot stripes and flushing both data and recovery information for stripes that are not frequently accessed, the cache can be used more efficiently and retain only those frequently used segments that measurably improve transaction performance. The recovery information in the controller cache may be protected by mirroring it to multiple controller caches, and because it is pinned in the caches rather than written and read back repeatedly, the burden on the mirror channel may actually be less than examples that do not pin the recovery information. Of course, it is understood that these features and advantages are shared among the various examples herein and that no one feature or advantage is required for any particular embodiment.

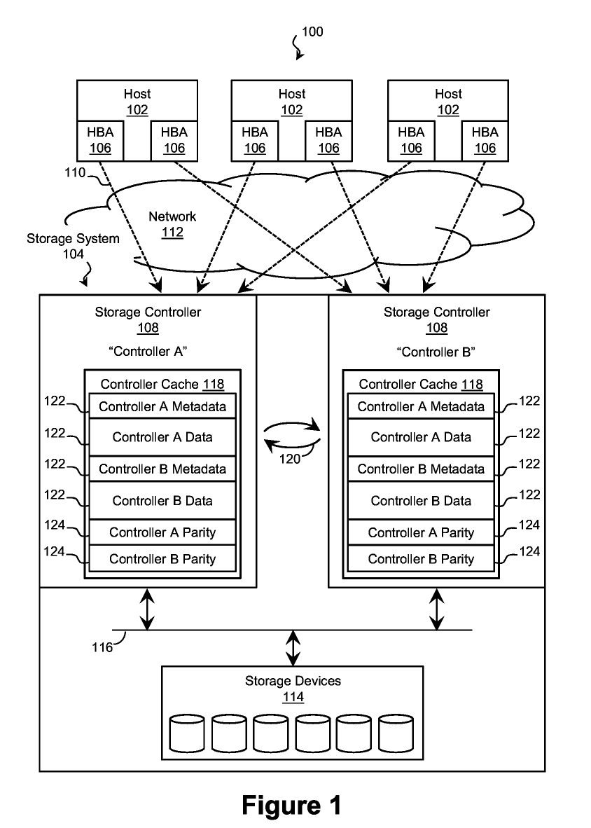

FIG. 1 is a schematic diagram of an exemplary storage architecture 100 according to aspects of the present disclosure. The storage architecture 100 includes a number of hosts 102 in communication with a number of storage systems 104. It is understood that for clarity and ease of explanation, only a single storage system 104 is illustrated, although any number of hosts 102 may be in communication with any number of storage systems 104. Furthermore, while the storage system 104 and each of the hosts 102 are referred to as singular entities, a storage system 104 or host 102 may include any number of computing devices and may range from a single computing system to a system cluster of any size. Accordingly, each host 102 and storage system 104 includes at least one computing system, which in turn includes a processor such as a microcontroller or a central processing unit (CPU) operable to perform various computing instructions. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a communication interface such as an Ethernet interface, a Wi-Fi (IEEE 802.11 or other suitable standard) interface, or any other suitable wired or wireless communication interface; and/or a user I/O interface coupled to one or more user I/O devices such as a keyboard, mouse, pointing device, or touchscreen.

With respect to the hosts 102, a host 102 includes any computing resource that is operable to exchange data with a storage system 104 by providing (initiating) data transactions to the storage system 104. In an exemplary embodiment, a host 102 includes a host bus adapter (HBA) 106 in communication with a storage controller 108 of the storage system 104. The HBA 106 provides an interface for communicating with the storage controller 108, and in that regard, may conform to any suitable hardware and/or software protocol. In various embodiments, the HBAs 106 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. In the illustrated embodiment, each HBA 106 is connected to a single storage controller 108, although in other embodiments, an HBA 106 is coupled to more than one storage controller 108.

Communications paths between the HBAs 106 and the storage controllers 108 are referred to as links 110. A link 110 may take the form of a direct connection (e.g., a single wire or other point-to-point connection), a networked connection, or any combination thereof. Thus, in some embodiments, one or more links 110 traverse a network 112, which may include any number of wired and/or wireless networks such as a Local Area Network (LAN), an Ethernet subnet, a PCI or PCIe subnet, a switched PCIe subnet, a Wide Area Network (WAN), a Metropolitan Area Network (MAN), the Internet, or the like. In some embodiments, a host 102 has multiple links 110 with a single storage controller 108 for redundancy. The multiple links 110 may be provided by a single HBA 106 or multiple HBAs 106. In some embodiments, multiple links 110 operate in parallel to increase bandwidth.

To interact with (e.g., read, write, modify, etc.) remote data, a host 102 sends one or more data transactions to the respective storage system 104 via the link 110. Data transactions are requests to read, write, or otherwise access data stored within a data storage device such as the storage system 104, and may contain fields that encode a command, data (i.e., information read or written by an application), metadata (i.e., information used by a storage system to store, retrieve, or otherwise manipulate the data such as a physical address, a logical address, a current location, data attributes, etc.), and/or any other relevant information.

Turning now to the storage system 104, transactions from the hosts 102 are received by the storage controllers 108, which exercise low-level control over the storage devices 114 in order to execute (perform) the data transactions on behalf of the hosts 102. The storage controllers 108 respond to hosts' data transactions in such a way that the storage devices 114 appear to be directly connected (local) to the hosts 102. In that regard, the exemplary storage system 104 contains any number of storage devices 114 in communication with any number of storage controllers 108 via a backplane 116. The backplane 116 may include Fibre Channel connections, SAS connections, iSCSI connections, FCoE connections, SATA connections, eSATA connections, and/or other suitable connections between the storage controllers 108 and the storage devices 114.

The storage system 104 may group the storage devices 114 for speed and/or redundancy using a virtualization technique such as RAID (Redundant Array of Independent/Inexpensive Disks). At a high level, virtualization includes mapping physical addresses of the storage devices into a virtual address space and presenting the virtual address space to the hosts 102. In this way, the storage system 104 represents the group of devices as a single device, often referred to as a volume. Thus, a host 102 can access the volume without concern for how it is distributed among the underlying storage devices. The virtualization technique may also provide data protection by duplicating or mirroring data across storage devices 114 or by generating recovery information, such as parity bits, from which the data can be recreated in the event of a failure.

In various examples, the underlying storage devices 114 include hard disk drives (HDDs), solid state drives (SSDs), optical drives, and/or any other suitable volatile or non-volatile data storage medium. In some embodiments, the storage devices 114 are arranged hierarchically and include a large pool of relatively slow storage devices and one or more caches (i.e., smaller memory pools typically utilizing faster storage media). Portions of the address space are mapped to the cache so that transactions directed to mapped addresses can be serviced using the cache. Accordingly, the larger and slower memory pool is accessed less frequently and in the background. In an embodiment, a storage device includes HDDs, while an associated cache includes NAND-based SSDs.

In addition to the caches of the storage devices 114, each storage controller 108 may also include a controller cache 118. Similar to a disk cache, the controller cache 118 may be used to store data to be written to or read from the storage devices 114. The controller caches 118 are typically much faster to access than the storage devices 114 and provide a mechanism for expediting data transactions. The controller caches 118 may include any volatile or non-volatile storage medium and common examples include battery-backed DRAM and flash memory.

The controller caches 118 may be mirrored to guard against data loss, and in a typical example, separate copies of transaction data are stored in the caches 118 of two or more different storage controllers 108. Thus, in an embodiment, a first storage controller 108 stores a copy of data and/or metadata in its controller cache 118 prior to performing the transaction on the storage devices 114. The first storage controller 108 may also provide the data and/or metadata to a second storage controller 108 over an inter-controller bus 120 for storing in the second controller's controller cache 118. This duplication may take place before the data is written to the storage devices 114. In this way, the storage system 104 can recreate the transaction should either storage controller 108 fail before the write to storage is complete.

In some embodiments, the controller caches 118 are partitioned, with each partition being set aside for data and/or metadata associated with a particular storage controller 108. Each partition may be associated with a particular storage controller 108, and for redundancy, the partitions may be mirrored between the storage controllers 108 using the inter-controller bus 120. Accordingly, in the illustrated embodiment, each controller cache 118 includes a data partition 122 and a metadata partition 122 associated with a first storage controller 108 (“Controller A”) and a data partition 122 and a metadata partition 122 associated with a second storage controller 108 (“Controller B”). In such embodiments, a storage controller 108 may use its own designated partitions 122 to perform data transactions and may use the partitions 122 that mirror other storage controllers 108 to recover transactions in the event of a storage controller 108 failure. In the illustrated embodiment, each controller cache 118 has separate partitions for data and metadata, although in further embodiments, a single partition 122 is used to store both data and metadata associated with a particular controller.

In the examples that follow, the controller caches 118 also include separate parity partitions 124. As described in detail below, the parity partitions 124 are used to cache recovery information, such as parity data for frequently accessed data stripes. Similar to data and metadata partitions, each parity partition 124 may be associated with a particular storage controller 108, and parity partitions 124 may be mirrored between storage controllers 108. A storage controller 108 may use its own designated parity partition 124 to perform data transactions and may use the parity partitions 124 that mirror other storage controllers 108 to recover data in the event of a storage controller 108 failure.

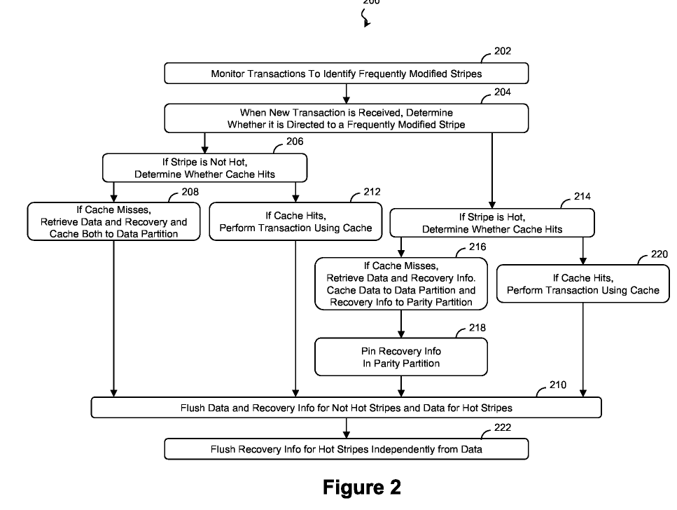

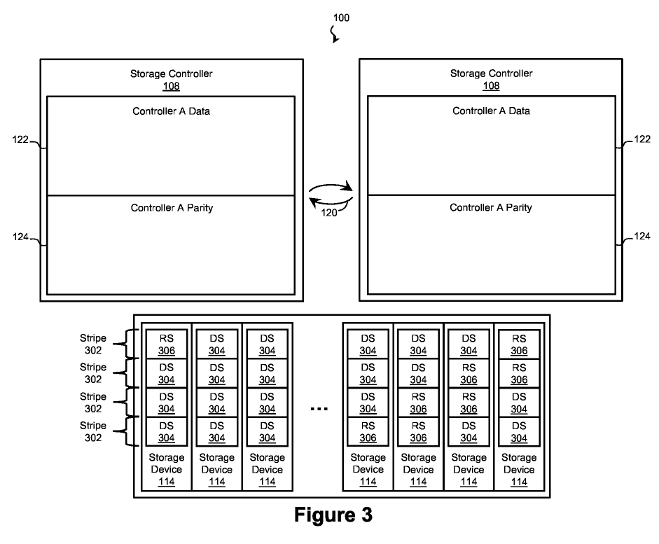

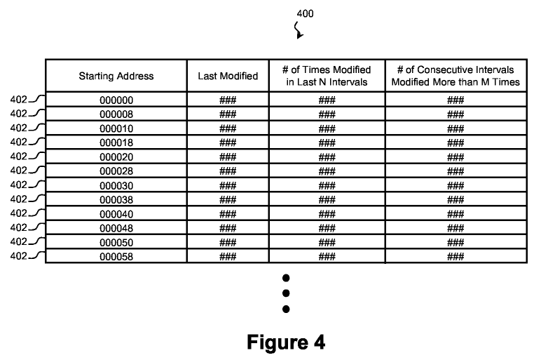

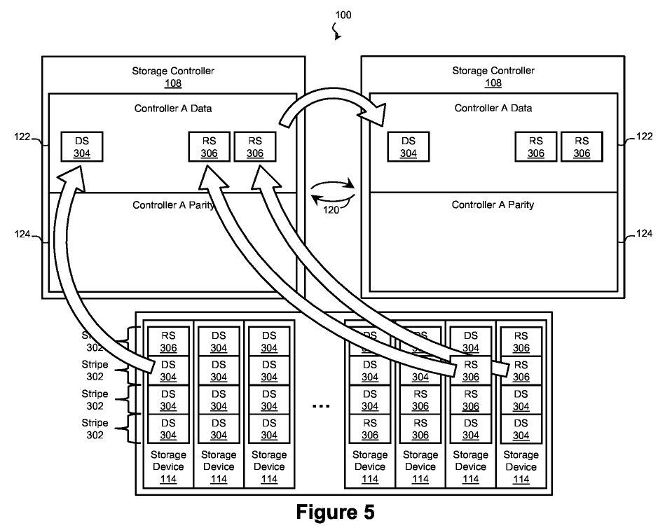

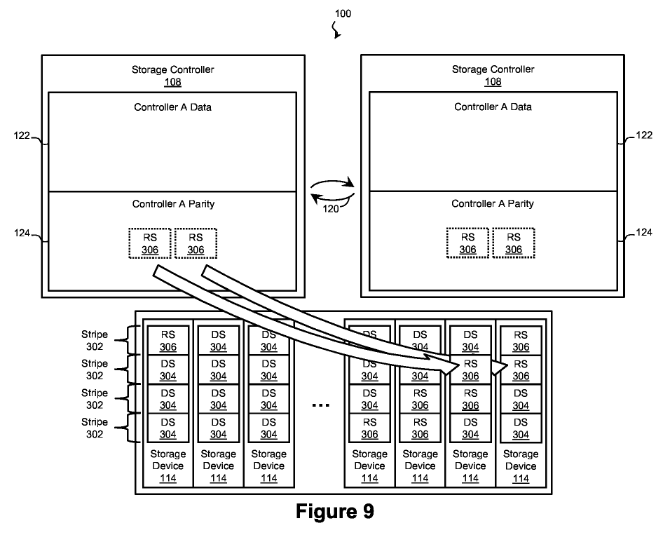

A system and technique for providing data redundancy using the parity partitions 124 is described with reference to FIGS. 2-9. FIG. 2 is a flow diagram of a method 200 of cache management according to aspects of the present disclosure. It is understood that additional steps can be provided before, during, and after the steps of the method 200 and that some of the steps described can be replaced or eliminated for other embodiments of the method 200. FIG. 3 is a memory diagram of a controller cache 118 and a set of storage devices 114 of an exemplary storage architecture 100 undergoing the method 200 according to aspects of the present disclosure. FIG. 4 is a memory diagram of an access log 400 according to aspects of the present disclosure. FIGS. 5-9 are memory diagrams of the controller cache 118 and the set of storage devices 114 of the exemplary storage architecture 100 at various stages throughout the method 200 according to aspects of the present disclosure. The storage architecture 100 of FIGS. 3 and 5-9 may be substantially similar to the storage architecture 100 of FIG. 1 in many regards. For example, the storage architecture 100 may include one or more controller caches 118 and storage devices 114 under the control of a storage controller 108, each element substantially similar to those described in the context of FIG. 1.

Referring first to block 202 of FIG. 2 and to FIG. 3, throughout the course of operation, the storage controllers 108 of the storage system 104 may identify data stripes that are frequently modified (i.e., “hot” data stripes). At a high level, a stripe is a group of data segments and recovery segments stored across more than one storage device 114. In the examples of FIG. 3, a storage controller 108 stores data on the storage devices 114 using a data protection scheme such as RAID 1 (mirroring), RAID 5 (striping with parity), or RAID 6 (striping with double parity). To do so, data is divided into stripes 302 and divided again into data segments 304. Each data segment 304 represents the portion of a stripe 302 allocated to a particular storage device 114, and while the data segments 304 may have any suitable size (e.g., 64K, 128K, 256K, 512K, etc.), they are typically uniform across storage devices 114. For example, the data protection scheme may utilize data segments 304 of 256K throughout the storage system 104. The data protection scheme may also be used to generate one or more recovery segments 306 for the stripe 302 based on the values of the data segments 304 therein. The data segments 304 and recovery segments 306 that make up a stripe 302 are then distributed among the storage devices 114 with one data segment 304 or recovery segment 306 per storage device 114.

RAID 5 provides one recovery segment 306 per stripe 302 regardless of how many data segments 304 are in the stripe 302, and allows recovery of data in the event that a single storage device fails. RAID 6 provides two recovery segments 306 per stripe 302 (sometimes identified as P and Q) regardless of how many data segments 304 are in the stripe 302, and allows recovery of data in the event that up to two storage devices fail. In many aspects, RAID 1 can be thought of as a degenerate case where the stripe size is one data segment 304 and one recovery segment 306, and the recovery segment 306 is an exact copy of the data segment 304. Of course, the principles of the present disclosure apply equally to other data protection schemes and other types of data grouping.

Referring to FIG. 4, to identify frequently modified data stripes, the storage controller 108 may record data transactions and the affected stripes 302 in an access log 400. The access log 400 may include a set of entries 402 each identifying one of the data stripes 302 and recording one or more attributes describing access patterns associated with the respective stripe 302 over various intervals of time. In that regard, the access log 400 may divide time into discrete intervals of any suitable duration. The entries 402 may be maintained in any suitable representation including a bitmap, a hash table, an associative array, a state table, a flat file, a relational database, a linked list, a tree, and/or other memory structure. In the illustrated embodiment, each entry 402 identifies a data stripe 302 according to a starting address and records the most recent interval in which any data segment 304 of the stripe 302 was modified. In the illustrated embodiment, each entry 402 further records the total or average number of times that any data segment 304 of the stripe was modified in the last N intervals, where N represents any suitable number. Tracking accesses over more than one interval may show longer-term trends to avoid distortions caused by stripes 302 that are hot for very brief durations. Similarly, in some embodiments, each entry records the number of consecutive intervals in which any data segment 304 of the stripe was accessed more than a threshold number of times. Of course these access attributes are merely exemplary, and the access log 400 may record any attribute that may help distinguish a stripe 302 as frequently modified.

The storage controller 108 may use the access log 400 to classify various stripes 302 as frequently modified by comparing the entries of the access log to one or more thresholds. A stripe 302 that exceeds a threshold may be classified as frequently modified. Other factors that may be considered include proximity to other frequently modified stripes, broader data access patterns, and other suitable criteria. Furthermore, in some examples, stripes 302 may be designated as frequently modified by a user or administrator. As described below, for frequently modified stripes 302, recovery information from the recovery segment(s) 306 may be pinned in the controller cache 118 to accelerate subsequent transactions.

Referring to block 204 of FIG. 2, when the storage system 104 receives a new write transaction, the storage controller 108 determines whether it is directed to one or more data segments 304 of a stripe 302 classified as frequently modified. If the stripe is not hot, referring to block 206 of FIG. 2, the storage controller 108 determines whether the write can be performed using only the contents of the controller cache 118 (a cache hit).

Referring to block 208 of FIG. 2 and to FIG. 5, if the storage controller 108 determines that the write cannot performed using the contents of the controller cache 118 as they currently stand (a cache miss), the storage controller retrieves one or more data segments 304 and/or recovery segments 306 from the storage devices 114. In some embodiments, the data protection scheme can regenerate recovery segments 306 without accessing the entire stripe 302. For example, RAID 5 and RAID 6 recovery segments 306 can be generated based on the old value of data segment(s) 304 being written, the new value of the data segment(s) 304 being written and the old value of the recovery segment(s) 306. Thus, in an 8+2 RAID 6 example where a single data segment 304 is being written, the transaction can be completed with three reads (one old data segment 304 and two old recovery segments 306) rather than reading all eight data segments 304.

The retrieved data segments 304 and recovery segments 306 are stored in the controller cache 118. For a stripe 302 that is not designated frequently accessed, the data segments 304 and the recovery segments 306 may be stored in the data partition 122 rather than the parity partition 124. The storage controller 108 generates new recovery information (e.g., parity values) based on the data to be written and updates the data segment(s) 304 and the recovery segment(s) 306 in the cache 118. In some embodiments, the storage controller 108 mirrors the retrieved segments and/or the updated segments in a controller cache 118 of another storage controller 108.

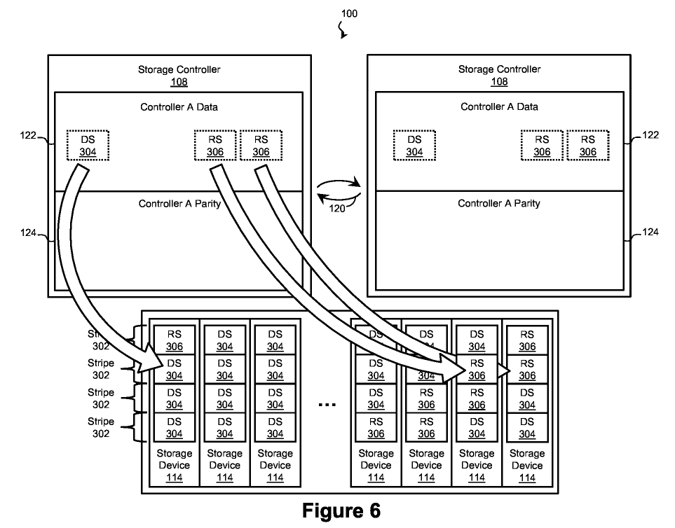

At various intervals, the contents of the controller cache 118 including the modified data segments 304 and recovery segments 306 are written to the storage devices 114 in a cache flush, as shown in block 210 and FIG. 6. The storage controller 108 may utilize any suitable cache algorithm to determine which portions of the data partition 122 to write back. For example, in various embodiments, the storage controller 108 implements a least recently used (LRU) algorithm, a pseudo-LRU algorithm, a least frequently used (LFU) algorithm, an adaptive algorithm, and/or other suitable algorithm.

If the storage controller 108 determines that the write hits in the cache in block 206, the method 200 proceeds to block 212, where the storage controller 108 writes to the relevant data segment(s) 304 and/or recovery segments 306 in the controller cache 118. In some embodiments, the storage controller 108 mirrors the updated data segment(s) 304 and recovery segments 306 in a controller cache 118 of another storage controller 108. When a cache flush is performed as shown in block 210, the updated values of the data segment(s) 304 and recovery segment(s) 306 are written to the storage devices 114.

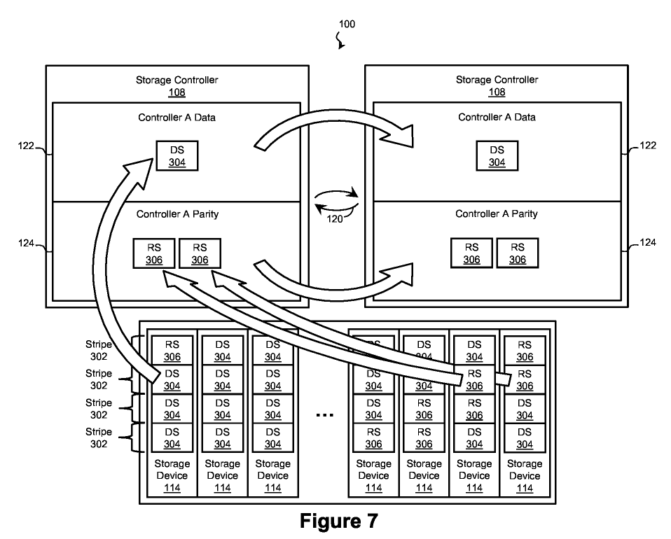

In contrast, when the storage controller 108 determines that a new write transaction is directed to a stripe 302 classified as frequently modified, the segments are cached differently to provide improved performance. Referring to block 214, upon determining that a new write transaction is directed to a frequently modified stripe 302, the storage controller determines whether the write results in a cache hit. If the write misses in the cache 118, the storage controller retrieves one or more data segments 304 and/or recovery segments 306 from the storage devices as shown in block 216 of FIG. 2 and FIG. 7. Here as well, in some embodiments, the data protection scheme can regenerate recovery segments 306 without accessing the entire stripe 302. Accordingly, in some such embodiments, the storage controller 108 only retrieves the data segments 304 and recovery segments 306 being modified.

For writes to hot stripes 302, the retrieved data segments 304 are stored in the data partition 122 of the controller cache 118 while the retrieved recovery segments 306 are stored in the parity partition 124. The storage controller 108 generates new recovery information (e.g., parity values) based on the data to be written and updates the data segment(s) 304 and the recovery segment(s) 306. In some embodiments, the storage controller 108 mirrors the retrieved segments and/or the updated segments (data segments 304 and recovery segments 306) in a controller cache 118 of another storage controller 108.

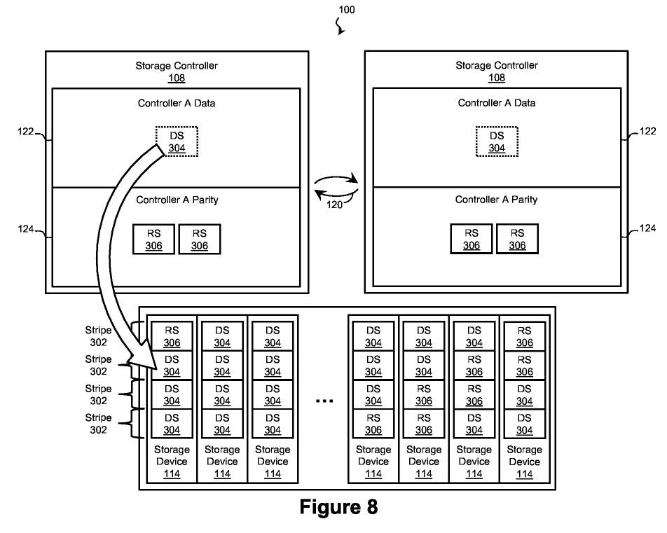

Referring to block 218 of FIG. 2, the updated recovery segments 306 are considered pinned in the parity partition 124 and will remain in the parity partition 124 even when the data segments 304 are flushed. Because the stripe 302 is frequently modified, future writes to the stripe 302 are expected. In stripes 302 with large numbers of data segments 304, the subsequent writes may not necessarily access the same data segments 304; however, each write to the stripe 302 will access the respective recovery segments 306 regardless of which data segment(s) 304 are being written. Therefore, the recovery segments 306 in the controller cache 118 are more likely to accelerate subsequent transactions than the data segments 304. This effect is magnified as the stripe 302 size grows. Referring to FIG. 8, at various intervals, the contents of the controller cache 118 are written to the storage devices 114 in a cache flush, as shown in block 210. The flush writes the data segments 304 and recovery segments 306 of the stripes 302 that are not frequently modified and writes the data segments 304 of the frequently modified stripes 302. However, the recovery segments 306 of the frequently modified stripes 302 are not written to the storage devices during this flush. They persist in the controller cache 118 in a dirty state.

If the storage controller 108 determines in block 214 that the write to the frequently modified stripe 302 hits in the controller cache 118, the transaction is performed using the cache 118 as shown in block 220. The transaction data segments 304 may hit or miss independently of the recovery segments 306. Accordingly, a hit in the controller cache 118 may still entail retrieving some data segment(s) 304 and/or recovery segment(s) 306 from the storage devices 114. Because the recovery segments 306 are retained in the cache 118 longer than the data segments 304, the recovery segments 306 are more likely to hit than the data segments 304. Thus, pinning the recovery segments 306 may increase the chances of a hit compared to not pinning and does so in a more efficient manner than pinning both data segments 304 and recovery segments 306. The storage controller 108 updates the data segments 304 and recovery segments 306, and when a cache flush is performed as shown in block 210, the new values of the data segments 304 are written to the storage devices as shown in FIG. 8.

Returning to the 8+2 RAID 6 example that writes to a single data segment 304, when a write to a stripe 302 that is not frequently modified misses completely, three segments (one data segment 304 and two recovery segments 306) are read from the storage devices 114 and the three segments are written to the storage devices 114 in the subsequent flush. In contrast, when a write to a hot stripe 302 misses completely, three segments are read from the storage devices 114, but only one segment (the data segment 304) is written to the storage devices during the flush because the write of the recovery segments 306 is deferred. This may reduce the impact of the flush operation. Furthermore, pinning the recovery segments 306 of the hot stripe 302 increases the chances of a partial cache hit. For a write to a single data segments 304 that hits on the recovery segments 306 but misses on the data segment 304, only the data segment 304 is read from the storage devices 114, and only the data segment 304 is written to the storage devices 114 during the flush. As will be recognized, the write that results in a partial cache hit may be much more efficient than a write that misses completely. By increase the likelihood of a partial cache hit, the use of pinned recovery segments 306 may dramatically reduce transaction latency.

Referring to block 222, a separate flush of the pinned recovery segments 306 may be performed that is distinct from the flush of block 210 that writes the data segments 304 and recovery segments 306 of the stripes 302 that are not frequently modified and the data segments 304 of the frequently modified stripes 302. The flush of the pinned recovery segments 306 may be performed significantly less frequently than the flush of block 210. For example, the pinned recovery segments 306 may be flushed if the associated stripe 302 is no longer classified as frequently accessed. In various embodiments, the pinned recovery segments 306 are flushed based on a volume transfer (transfer of ownership of a volume from one storage controller 108 to another), a scheduled shutdown, and/or an emergency event such as power loss, hardware failure, or system error. In some embodiments, the pinned recovery segments 306 are flushed when the storage system 104 is idle, nearly idle, and/or when the number of received transactions received during a certain interval falls below a threshold. By flushing the pinned recovery segments 306 independently and less frequently, the likelihood of a cache hit increases even as the writes to the storage devices 114 decrease. The storage controller 108 may utilize any suitable cache algorithm to determine which portions of the parity partition 124 to write back. For example, in various embodiments, the storage controller 108 implements an LRU algorithm, a pseudo-LRU algorithm, an LFU algorithm, an adaptive algorithm, and/or other suitable algorithm.

The present embodiments can take the form of an entirely hardware embodiment, an entirely software embodiment, or an embodiment containing both hardware and software elements. In that regard, in some embodiments, the computing system is programmable and is programmed to execute processes including those associated with the processes of the method 400 discussed herein. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium can be an electronic, magnetic, optical, electromagnetic, infrared, or a semiconductor system (or apparatus or device). In some embodiments, the storage controllers 108 and/or one or more processors running in one or more of the storage system 104 or the hosts 102 execute code to implement the actions described above.

Accordingly, a system, method, and machine-readable medium is provided for a storage system that caches data and recovery information based on data usage patterns. In some embodiments, a method is provided that includes receiving a data transaction by a storage controller of a storage system. The storage controller determines whether the data transaction is directed to a data stripe classified as frequently accessed. Data associated with the data transaction is cached in a cache of the storage controller, and recovery information associated with the data transaction is cached in the cache. The recovery information is pinned in the cache based on the data transaction being directed to the data stripe that is classified as frequently accessed. The data from the cache is flushed independently from the recovery information based on the recovery information being pinned. In some embodiments, the data transaction is a first data transaction and the method further includes receiving a second data transaction by the storage controller of the storage system. Data associated with the second data transaction is cached in the cache, and recovery information associated with the second data transaction is cached in the cache. The data associated with the second data transaction is flushed together with the recovery information associated with the second data transaction based on the second transaction being directed to a data stripe that is not classified as frequently accessed. In some such embodiments, the caching of the data includes caching the data to a first partition of the cache, and the caching of the recovery information includes caching the recovery information to a second partition of the cache based on the data transaction being directed to the data stripe that is classified as frequently accessed.

In further embodiments, a non-transitory machine readable medium having stored thereon instructions for performing a method of executing a data transaction is provided. The medium includes machine executable code which when executed by at least one machine, causes the machine to: receive a data transaction from a host system; determine whether the data transaction is directed to a memory structure designated as frequently modified; cache data of the data transaction in a controller cache; cache recovery information of the data transaction in the controller cache; and retain the recovery information in the controller cache after the data has been flushed from the controller cache based on the data transaction being directed to a memory structure designated as frequently modified. In some such embodiments, the recovery information includes parity information. In some embodiments, the non-transitory machine readable medium includes further machine executable code that causes the machine to flush the recovery information in the controller cache based on the memory structure losing the designation of frequently modified.

In yet further embodiments, a computing device is provided that includes a memory containing machine readable medium comprising machine executable code having stored thereon instructions for performing a method of executing a data transaction. The processor is configured to execute the machine executable code to: receive a transaction from a host; determine whether the transaction is directed to a data stripe classified as frequently accessed; cache data associated with the transaction and recovery information associated with the transaction in different partitions of a controller cache based on the transaction being directed to the data stripe classified as frequently accessed; and pin the recovery information in the controller cache based on the transaction being directed to the data stripe classified as frequently accessed. In some such embodiments, the processor is further configured to execute the machine executable code to flush the recovery information from the controller cache based on at least one of: a volume transfer, a scheduled shutdown, a power loss, a hardware failure, or a system error.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
receiving a data transaction by a storage controller of a storage system;
determining whether the data transaction is directed to a data stripe classified as frequently accessed;
caching data associated with the data transaction in a cache of the storage controller;
caching recovery information associated with the data transaction in the cache;
pinning the recovery information in the cache based on the data transaction being directed to the data stripe that is classified as frequently accessed; and
flushing the data from the cache independently from the recovery information based on the recovery information being pinned.

2. The method of claim 1, wherein the data transaction is a first data transaction, the method further comprising:
receiving a second data transaction by the storage controller of the storage system;
caching data associated with the second data transaction in the cache;
caching recovery information associated with the second data transaction in the cache; and
flushing the data associated with the second data transaction together with the recovery information associated with the second data transaction based on the second transaction being directed to a data stripe that is not classified as frequently accessed.

3. The method of claim 1, wherein the caching of the data includes caching the data to a first partition of the cache, and wherein the caching of the recovery information includes caching the recovery information to a second partition of the cache based on the data transaction being directed to the data stripe that is classified as frequently accessed.

4. The method of claim 1, wherein the cache is a first cache and the storage controller is a first storage controller, the method further comprising mirroring the data and the recovery information in a second cache of a second storage controller.

5. The method of claim 1, wherein the recovery information includes at least one of: RAID 5 parity information or RAID 6 parity information.

6. The method of claim 1, further comprising flushing the recovery information, and wherein the flushing of the recovery information is performed separate from the flushing of the data.

7. The method of claim 6, wherein the flushing of the recovery information is performed based on the data stripe being no longer classified as frequently accessed.

8. The method of claim 6, wherein the flushing of the recovery information is performed based on at least one of: a volume transfer, a scheduled shutdown, a power loss, a hardware failure, or a system error.

9. The method of claim 6, wherein the flushing of the recovery information is performed based on a count of received transactions during an interval of time falling below a threshold.

10. A non-transitory machine readable medium having stored thereon instructions for performing a method of executing a data transaction, comprising machine executable code which when executed by at least one machine, causes the machine to:
receive a data transaction from a host system;
determine whether the data transaction is directed to a memory structure designated as frequently modified;
cache data of the data transaction in a controller cache;
cache recovery information of the data transaction in the controller cache; and
retain the recovery information in the controller cache after the data has been flushed from the controller cache based on the data transaction being directed to a memory structure designated as frequently modified.

11. The non-transitory machine readable medium of claim 10, wherein the recovery information includes parity information.

12. The non-transitory machine readable medium of claim 10, wherein the recovery information and the data are cached to different partitions of the controller cache based on the data transaction being directed to the memory structure designated as frequently modified.

13. The non-transitory machine readable medium of claim 10, wherein the data transaction is a first data transaction, the non-transitory machine readable medium comprising further machine executable code that causes the machine to:
receive a second data transaction;
cache data of the second data transaction and recovery information of the second controller in the controller cache;
flush the data of the second data transaction together with the recovery information of the second controller based on the second data transaction being directed to a memory structure that is not designated as frequently modified.

14. The non-transitory machine readable medium of claim 10 comprising further machine executable code that causes the machine to flush the recovery information in the controller cache based on the memory structure losing the designation of frequently modified.

15. A computing device comprising:
a memory containing machine readable medium comprising machine executable code having stored thereon instructions for performing a method of executing a data transaction;
a processor coupled to the memory, the processor configured to execute the machine executable code to:
receive a transaction from a host;
determine whether the transaction is directed to a data stripe classified as frequently accessed;
cache data associated with the transaction and recovery information associated with the transaction in different partitions of a controller cache based on the transaction being directed to the data stripe classified as frequently accessed; and
pin the recovery information in the controller cache based on the transaction being directed to the data stripe classified as frequently accessed.

16. The computing device of claim 15, wherein the processor is further configured to execute the machine executable code to:
flush the recovery information from the controller cache when the data stripe is no longer classified as frequently accessed.

17. The computing device of claim 15, wherein the processor is further configured to execute the machine executable code to:
flush the recovery information from the controller cache based on at least one of: a volume transfer, a scheduled shutdown, a power loss, a hardware failure, or a system error.

18. The computing device of claim 15, wherein the transaction is a first transaction and wherein the processor is further configured to execute the machine executable code to:
receive a second transaction;
cache data associated with the second transaction and recovery information associated with the second transaction in a single partition of the controller cache based on the second transaction being directed to the data stripe that is not classified as frequently accessed;
flush the data associated with the second transaction and the recovery information associated with the second transaction together.

19. The computing device of claim 15, wherein the processor is further configured to execute the machine executable code to:
mirror the data and the recovery information in another controller cache.

20. The computing device of claim 15, wherein the recovery information includes at least one of: RAID 5 parity information or RAID 6 parity information.
